(19) United States
(12) Patent Application Publication
(10) Pub. No.: US 2013/0135250 A1
(43) Pub. Date: May 30, 2013

(54) APPARATUS AND METHOD FOR SENSING TOUCH

(71) Applicant: Pantech CO., LTD., Seoul (KR)

(72) Inventor: Chang-Jin SONG, Seoul (KR)

(73) Assignee: PANTECH CO., LTD., Seoul (KR)

(21) Appl. No.: 13/685,016

(22) Filed: Nov. 26, 2012

(30) Foreign Application Priority Data
Nov. 30, 2011 (KR) 10-2011-0126928

(51) Int. Cl. G06F 3/044

(52) U.S. Cl. CPC G06F 3/044
USPC 345/174

(57) ABSTRACT

An apparatus to sense a touch includes a touch panel to sense a touch based on a change in capacitance, in which the touch panel includes a first sensing layer including a plurality of first electrode patterns, and a second sensing layer including a plurality of second electrode patterns. The apparatus also includes a data processing unit to calculate a location coordinate of the sensed touch based on the change in capacitance. A method for sensing a touch including receiving a signal indicating a change in capacitance on at least one of a first sensing layer and a second sensing layer in response to the touch inputted on a touch panel; and calculating a location of the touch on the touch panel based on the change in capacitance.

### CROSS-REFERENCE TO RELATED APPLICATION

This application claims the benefit under 35 U.S.C. §119(a) of Korean Patent Application No. 10-2011-0126928, filed on Nov. 30, 2011, in the Korean Intellectual Property Office, the entire disclosure of which is hereby incorporated herein by reference for all purposes.

### BACKGROUND

1. Field

The following description relates to an apparatus and a method for sensing touch.

2. Discussion of the Background

A touch screen panel has a transparent display region, and, if a desired point of the display region is touched, the touch screen recognizes the location of the touch, and executes an operation or displays the location of the touch as display information. The touch screen panels are classified as one of an ultrasonic touch panel, an Infrared ray (IR) touch panel, a resistive touch panel, and a capacitive touch panel according to manufacturing methods. Further, some portable terminals have adapted the capacitive touch panel due to size and design issues.

The touch screen panel is used in various types of smart phones. However, as large display screens are more widely used, the smart phones have become larger as well. Even though mobile phone manufacturers have made efforts to reduce the size of the smart phones while maintaining a larger screen, there is difficulty in doing so since wirings must be arranged in a specific pattern in a touch screen panel.

### SUMMARY

Exemplary embodiments of the present invention provide an apparatus and a method for sensing a touch.

Additional features of the invention will be set forth in the description which follows, and in part will be apparent from the description, or may be learned by practice of the invention.

Exemplary embodiments of the present invention provide an apparatus to sense a touch including a touch panel to sense a touch based on a change in capacitance, the touch panel including: a first sensing layer including a plurality of first electrode patterns, and a second sensing layer including a plurality of second electrode patterns; and a data processing unit to calculate a location coordinate of the sensed touch based on the change in capacitance.

Exemplary embodiments of the present invention provide a method for sensing a touch including receiving a signal indicating a change in capacitance on at least one of a first sensing layer and a second sensing layer in response to the touch inputted on a touch panel; and calculating a location of the touch on the touch panel based on the change in capacitance.

Exemplary embodiments of the present invention provide a touch panel including a first sensing layer including a bent first electrode pattern; and a second sensing layer including a bent second electrode pattern, in which the first sensing layer overlaps the second sensing layer to form a grid of electrode patterns, and a signal outputting unit is disposed on at least one of the first sensing layer and the second sensing layer.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an apparatus to sense a touch according to an exemplary embodiment of the present invention.

FIG. 2 is a diagram illustrating sensing layers of a touch panel according to an exemplary embodiment of the present invention.

FIG. 3 is a diagram illustrating a method for sensing a touch on a sensing layer according to an exemplary embodiment of the present invention.

FIG. 4 is a diagram illustrating a first signal output in response to a touch on a first sensing layer according to an exemplary embodiment of the present invention.

FIG. 5 is a diagram illustrating a second signal output in response to a touch on a second sensing layer according to an exemplary embodiment of the present invention.

FIG. 6 is a diagram illustrating a method for calculating a location of a touch according to an exemplary embodiment of the present invention.

FIG. 7 is a diagram illustrating a first signal output in response to multiple touch inputs on a first sensing layer according an exemplary embodiment of the present invention.

FIG. 8 is a diagram illustrating a second signal output in response to multiple touch inputs on a second sensing layer according to an exemplary embodiment of the present invention.

FIG. 9 is a diagram illustrating electrode patterns of a touch panel according to an exemplary embodiment of the present invention.

FIG. 10 is a diagram illustrating electrode patterns of a touch panel according to an exemplary embodiment of the present invention.

FIG. 11 is a diagram illustrating electrode patterns of a touch panel according to an exemplary embodiment of the present invention.

FIG. 12 is a cross-sectional view of a touch panel according to an exemplary embodiment of the present invention.

FIG. 13 is a flow chart illustrating a method for sensing a touch according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

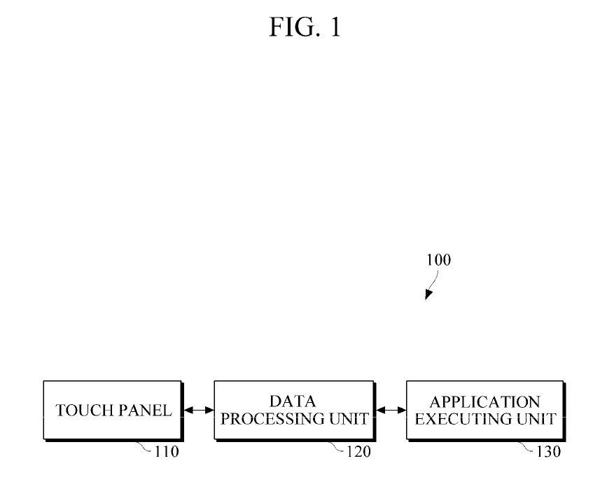

FIG. 1 is a diagram illustrating an apparatus to sense a touch according to an exemplary embodiment of the present invention.

As shown in FIG. 1, apparatus 100 to sense a touch includes a touch panel 110, a data processing unit 120, and an application executing unit 130. The apparatus 100 may be implemented in various kinds of electric devices, including, without limitation, a mobile phone, a smart phone, and a Moving Picture Experts Group (MPEG)-1 or MPEG-2 Audio Layer III (MP3) player.

The touch panel 110 may transmit a signal to the data processing unit 120, in which the signal may indicate a change in capacitance that may be detected in response to a detected touch. The touch panel 110 may be arranged above a display panel, such as a Liquid Crystal Display (LCD) (not shown), and may be a touch screen panel, which may allow light emitted from the display panel to pass through to reach a user. The data processing unit 120 may process the signal received from the touch panel to calculate a location of the touch, and transmit the calculated location of the touch to the application executing unit 130. The application executing unit 130 may control one or more hardware components of the apparatus 100 to sense a touch based on the calculated location of the touch or execute a specific operation of a currently-running application.

The touch panel 110 may be capable of sensing two-dimensional (2D) coordinate locations without wirings, which may be arranged on the side of a touch panel. Accordingly, the touch panel apparatus 110 may be able to sense a touch while being reduced in width due, at least in part, to lack of wiring arranged on the side of the touch panel 110. The touch panel 110 may include a first sensing layer and a second sensing layer to overlap each other. Each of the first sensing layer and a second sensing layer may have a plurality of electrode patterns arranged thereon, such that the plurality of electrode patterns can form a grid of electrodes when the first sensing layer and the second sensing layer overlap each other.

The data processing unit 120 may receive a first signal indicating a change in capacitance sensed on the first sensing layer, and a second signal indicating a change in capacitance sensed on the second sensing layer, process the first signal and the second signal, and calculate a location corresponding to the first signal and the second signal. The change in capacitance sensed on the touch panel 110 may be proportional to the contact area of a finger or other utensil, which may be in contact with the touch panel 110. Therefore, the data processing unit 120 may calculate a contact area ratio of adjacent electrodes in contact with a finger or other utensil, normalize the contact area ratio of the adjacent electrodes, and calculate coordinates of the contact area. Although change in capacitance sensed is described with respect to a detected touch, aspects of the invention are not limited thereto. For example, a change in capacitance may be sensed in response to a part of a user or utensil coming within a reference proximity to a touch panel. Further, the touch panel may be a pressure sensitive touch panel, which may calculate a contact area according to pressure.

More specifically, the data processing unit 120 may calculate a touch-sensed area in one or more of first electrode patterns using the pulse pattern of the first signal, and calculate at least one of an X-axis coordinate and a Y-axis coordinate using the touch area in one or more of the first electrode patterns. Similarly, the data processing unit 120 may calculate a touch-sensed area in one or more of second electrode patterns using the pulse pattern of the second signal, and calculate at least one of an X-axis coordinate and a Y-axis coordinate using the touch area in one or more of the second electrode patterns.

Hereinafter, a configuration of the touch panel 110 and a method for sensing a touch using the touch panel 110 will be provided in more detail.

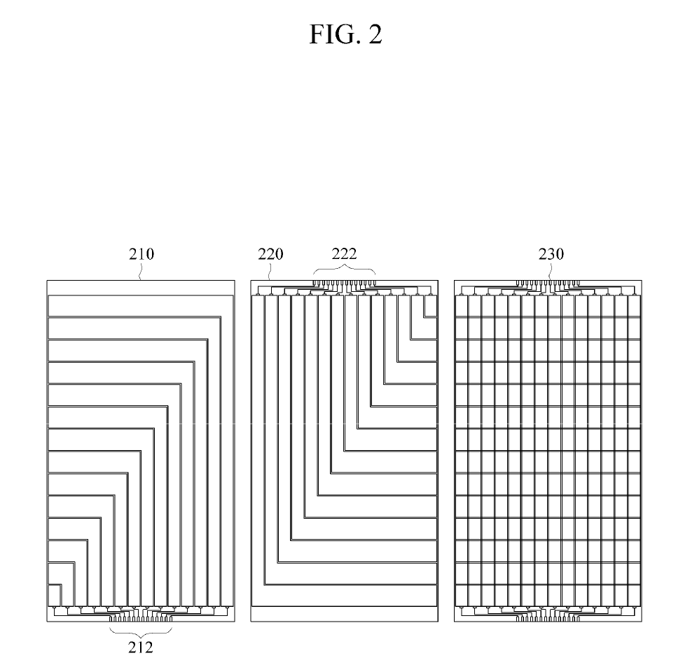

FIG. 2 is a diagram illustrating sensing layers of a touch panel according to an exemplary embodiment of the present invention.

FIG. 2 illustrates configurations of a first sensing layer 210 and a second sensing layer 220. Further, FIG. 2 illustrates a configuration 230 where the first sensing layer 210 and the second sensing layer 220 overlap each other.

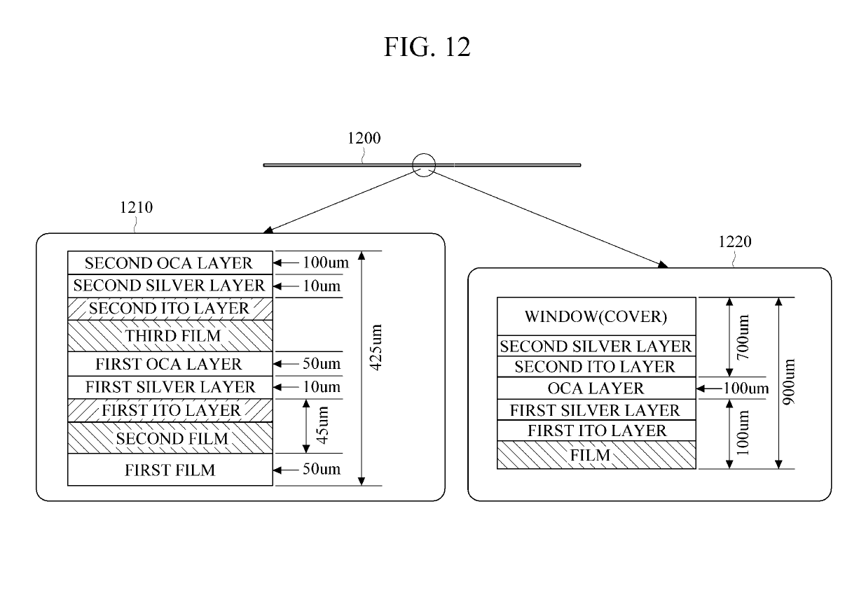

The first sensing layer 210 may be composed of a transparent film or glass materials. The first sensing layer 210 may be formed by evenly applying Indium Tin Oxide (ITO) on a display region of a transparent film or a thin transparent sheet, forming a plurality of patterns by an etching operation and removing the ITO from gaps or intervals disposed between the patterns, by which insulation between the patterns may be achieved, and connecting wirings to end portions of each ITO pattern to transmit a capacitance value of one or more ITO patterns to the data processing unit 120. Further, the wirings may be made of conductive metals, such as silver and copper. The second sensing layer 220 may be manufactured in a similar or the same manner as the first sensing layer 210, and the first sensing layer 210 and the second sensing layer 220 may be disposed to overlap each other. Further, the first sensing layer 210 and the second sensing layer 220 may be disposed to overlap one another to form a touch panel. In an example, component 1210 of FIG. 12 shows a cross-sectional view of a touch panel formed by overlapping or attaching two sensing layers.

Further, the first sensing layer 210 and the second sensing layer 220 may be combined as one sheet by forming ITO patterns and wirings on one surface of a film or glass sheet for the first sensing layer 210 and then forming the second sensing layer 220 on the opposite surface in a similar or the same manner as the first sensing layer 210. Further, the first sensing layer 210 may be formed or disposed on one surface of a film or glass sheet, an insulation process may be performed on the first sensing layer 210, and the second sensing layer 220 may be formed or disposed on the insulation-processed layer, which may reduce the thickness of the touch panel 110. In an example, component 1220 of FIG. 12 shows a cross-sectional view of a touch panel formed by this method.

In the above three methods for configuring a touch panel, the touch panel may include a film, which may support disposition of a first sensing layer and a second sensing layer.

The first sensing layer 210 and the second sensing layer 220, respectively, may include a plurality of electrode patterns.

One or more of the electrodes patterns formed on the first sensing layer 210 may be referred to as a first electrode pattern, and one or more of electrode patterns formed on the second sensing layer 220 may be referred to as a second electrode pattern. The number of the first electrode patterns may be identical to the number of the second electrode patterns. Although FIG. 2 illustrates a case where the first sensing layer 210 and the second sensing layer 220 respectively include fourteen electrode patterns, aspects of the invention are not limited thereto. A plurality of the first electrode patterns and a plurality of the second electrode patterns may respectively be bent in a shape of [symbol] , as shown in FIG. 2.

Referring to FIG. 2, the first sensing layer 210 and the second sensing layer 220, respectively, have a rectangular shape. However, aspects of the invention are not limited thereto, such that the first and second sensing layers 210 and 220 may have a variety of shapes, for example, the first and second sensing layers 210 and 220 may have a triangular or other polygonal, circular, elliptical, or other shape. The first sensing layer 210 and the second sensing layer 220 are respectively divided diagonally into two regions. More specifically, the first sensing layer 210 and the second sensing layer 220 may be respectively divided diagonally by an imaginary line connecting the top right apex and the bottom left apex into an upper left region and a lower right region.

The upper left region and the bottom right region of the first sensing layer divided diagonally may be referred to as a first region and a second region, respectively. The plurality of the first electrode patterns are arranged horizontally or along a first axis in the first region, and are bent at the diagonal dividing line to be arranged perpendicularly along a second axis in the second region. More specifically, the plurality of first electrode patterns is bent in a shape of [symbol] or an ‘L’ shape. The horizontal width and the perpendicular width of the plurality of the first electrode patterns may be different or the same. In addition, the plurality of the first electrodes may be bent at right angles. However, aspects of the invention are not limited thereto, such that the plurality of first electrodes may be bent at various angles, such as 75°, 45°, 30°, or 15°.

With respect to the second sensing layer 220, the plurality of the second electrode patterns are arranged horizontally in a third region and are bent at the diagonal dividing line to be arranged perpendicularly in the fourth region. The third region may correspond to or overlap the first region and the fourth region may correspond to or overlap the second region when the first sensing layer 210 and the second sensing layer 220 are disposed to overlap one another. The horizontal width and the perpendicular width of the plurality of the second electrode patterns may be different. Further, the plurality of the first electrode patterns and the plurality of the second electrode patterns may have the same horizontal width and the same perpendicular width.

The plurality of the first electrode patterns on the first sensing layer 210 may be connected to wirings, which may be used to output to the data processing unit 120 a signal indicating a sensed change in capacitance. Similarly, the plurality of the second electrode patterns on the second sensing layer 220 may be connected to wirings, which may be used to output to the data processing unit 120 a signal indicating a sensed change in capacitance. A first group of the wirings, in which one or more wiring connected to one or more of the first electrode patterns, may refer to the first signal outputting unit 212. A second group of the wirings, in which one or more wiring connected to one or more of the second electrode patterns, may refer to the second signal outputting unit 222. A scan signal inputting unit may provide a scan signal to sense a change in capacitance on at least one of the first sensing layer 210 and the second sensing layer 220, and may be connected to at least one of the first sensing layer 210 and the second sensing layer 220.

In a touch panel of a related art, wirings of two sensing layers may be arranged perpendicularly on the side of the touch panel to recognize coordinate values along the X and Y axes with respect to a location of a touch. However, referring to FIG. 2, according to the exemplary embodiment of the present invention, the first signal outputting unit 212 and the second signal outputting unit 222 are arranged to face each other without wirings on the side of the touch panel 110. More specifically, exemplary embodiments of the present invention provide two sensing layers without additional wirings disposed on the side of a touch panel.

Component 230 may illustrate an overlap configuration of the first sensing layer 210 and the second sensing layer 220. As shown in FIG. 2, the plurality of the first electrode patterns and the plurality of the second electrode patterns overlap each other to form a grid of electrodes.

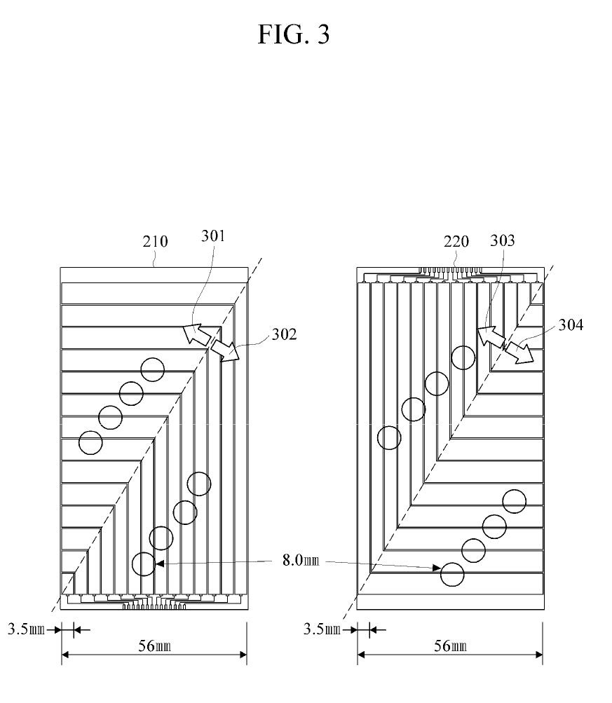

FIG. 3 is a diagram illustrating a method for sensing a touch on a sensing layer according to an exemplary embodiment of the present invention.

FIG. 3 illustrates the size of perpendicular widths and horizontal widths of each of the first sensing layer 210 and the second sensing layer 220. As shown in FIG. 3, at least one of the plurality of the first electrode patterns has a perpendicular width of 3.5 millimeter (mm) and a horizontal width of 8 mm. In addition, at least one of the second electrode patterns has a perpendicular width of 3.5 mm and a horizontal width of 8 mm. A general touch input may have a width of 8 mm.

In FIG. 3, each circle of the first sensing layer 210 may indicate a point at which a touch is inputted. In response to the inputted touch, the first sensing layer 210 and the second sensing layer 220 may have different signal waveforms or different signal pulse patterns indicating a change in capacitance, which may occur in response to the inputted touch. For example, when a touch is inputted in the first region of the first sensing layer 210, a change in capacitance may be sensed in two electrode patterns. Further, when a touch is inputted in the second region of the first sensing layer 210, a change in capacitance may be sensed in three electrode patterns.

Accordingly, the data processing unit 120 of FIG. 1 may analyze a pulse pattern of an output waveform of a signal indicating a change in capacitance that may occur at a detected touch point on the first sensing layer 210, and, in response to a touch on the same electrode pattern, the data processing unit 120 may determine whether the touch is inputted in the first region or to the second region.

When the horizontal direction and the perpendicular direction of the first sensing layer 210 are provided along an X axis and a Y axis, respectively, the data processing unit 120 may determines a location of an inputted touch in the first region indicated by an arrow key 301 as a Y-axis coordinate, and a location of an inputted touch in the second region indicated by an arrow key 302 as an X-axis coordinate.

In FIG. 3, each circle on the second sensing layer 220 may indicate a point at which a touch is inputted or detected. When a touch is inputted or detected in the third region of the second sensing layer 220, the third region being indicated by an arrow key 303, a change in capacitance may be sensed in three electrode patterns. Further, when a touch is inputted or detected in the fourth region of the second sensing layer 220, the fourth region being indicated by an arrow key 304, a change in capacitance may be sensed in two electrode patterns. Therefore, the data processing unit 120 of FIG. 1 may analyze a pulse pattern of an output waveform of a signal indicating a change in capacitance that may occur at a touch point on the second sensing layer 220, and, in response to a touch detected on the same electrode pattern, determine whether the touch is inputted in the third region or the fourth region.

When the horizontal direction and the perpendicular direction of the second sensing layer 220 corresponds to an X axis and a Y axis, respectively, the data processing unit 120 may determine a location of a touch occurring in the third region as an X-axis coordinate, and a location of a touch occurring in the fourth region as a Y axis coordinate.

More specifically, the data processing unit 120 may recognize the first signal and the second signal as an X-axis signal and a Y-axis signal, or vice versa, of the touch by analyzing a pulse pattern of a first signal and a pulse pattern of a second signal. The pulse pattern may be presented in various kinds of forms, including varying number of the pulse patterns, the area ratio of the pulse patterns, and the height of pulse patterns. For example, the number of the pulses of the first signal may be different from the number of the pulses of the second signal. As shown in FIG. 3, the first signal may have two pulse patterns and the second signal may have three pulse patterns.

However, the first sensing layer 210 and the second sensing layer 220 shown in FIG. 3 are exemplary, and each of the first sensing layer 210 and the second sensing layer 220 may have the horizontal width and/or the perpendicular width wider or narrower than it is illustrated in FIG. 3. For example, the first electrode patterns may have a 3 mm perpendicular width and a 6 mm horizontal width. In addition, the second electrode patterns may have a 3 mm perpendicular width and a 6 mm horizontal width.

Further, if a general user touch input to be sensed is determined to be 8 mm-wide, a change in capacitance may be sensed in three electrode patterns in response to a touch in the first region of the first sensing layer 210, and a change in capacitance may be sensed in four electrode patterns in response to a touch in the second region of the first sensing layer 210. In addition, a change in capacitance may be sensed in four electrode patterns in response to a touch in the third region of the second sensing layer 220, and a change in capacitance may be sensed in three electrode patterns in response to a touch in the fourth region of the second sensing layer 220.

Further, the data processing unit 120 may calculate the area ratio of the plurality of pulses of the first signal and the area ratio of the plurality of pulses of the second signal, and recognize the first signal as an X-axis signal and the second signal as a Y-axis signal, or vice versa. In addition, the data processing unit 120 may set basic features of a signal to be recognized as an X-axis coordinate and basic features of a signal to be recognized as a Y-axis coordinate, store the basic features with respect to both the X-axis coordinate and the Y-axis coordinate, analyze features of a received signal based on the stored basic features, and determine whether the received signal is the X-axis signal or the Y-axis signal.

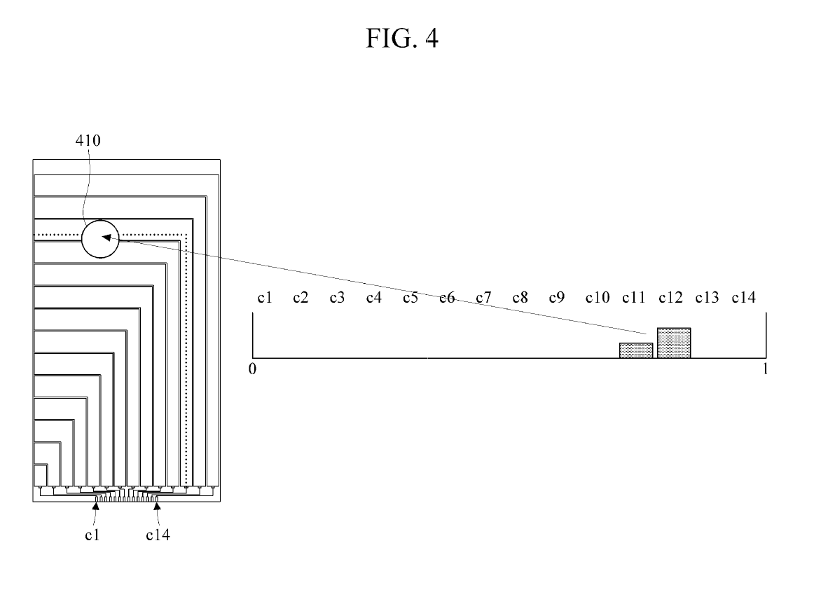

FIG. 4 is a diagram illustrating the first signal output in response to a touch on a first sensing layer according to an exemplary embodiment of the present invention.

The plurality of the first electrode patterns and the plurality of the second electrode patterns may be channels to which a signal may be outputted in response to a change in capacitance. Referring to FIG. 4, when a touch input is detected at the point 410, a signal waveform shown in the right-hand side of FIG. 4 may be output through the first signal outputting unit to the eleventh channel c11 and the twelfth channel c12.

The data processing unit 120 may analyze a pulse pattern of the signal waveform shown in FIG. 4, sense a signal occurring in two channels, and calculate a Y-axis coordinate of the point 410 in the first region using the sensed signal. Further, the data processing unit 120 may calculate as, for example, 3:5 the area ratio of the pulses between the eleventh channel c11 and the twelfth channel c12, both showing the pulse pattern of the first signal, determine that the area ratio does not correspond to the second region, and calculate a Y-axis coordinate of the touch using the first signal.

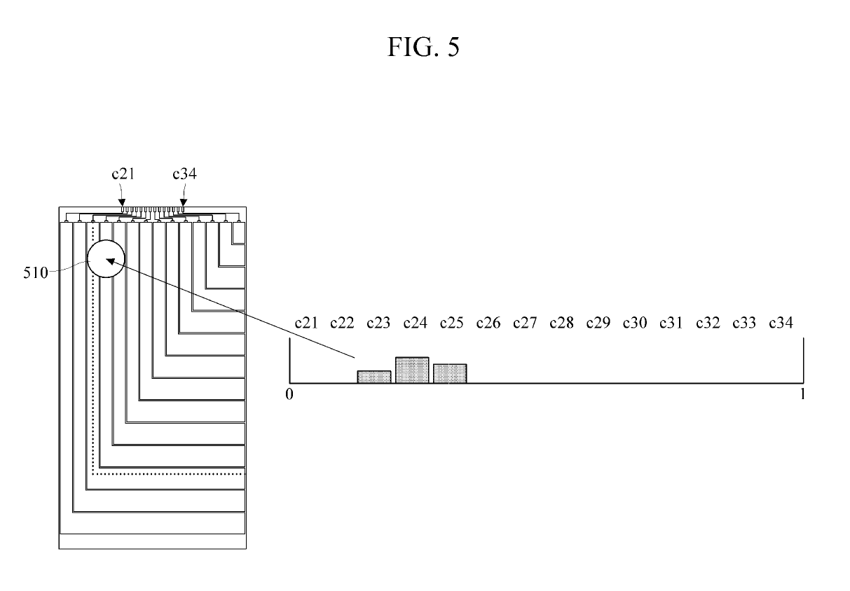

FIG. 5 is a diagram illustrating the second signal output in response to a touch in a second sensing layer according to an exemplary embodiment of the present invention.

Referring to FIG. 5, a point 510 may correspond to the point 410 of FIG. 4. More specifically, if first sensing layer of FIG. 4 overlaps the second sensing layer of FIG. 5, a touch input detected at a first position on the first sensing layer may be also detected on a corresponding position, which may be the same position as the first position, on the second sensing layer. Accordingly, when a touch is inputted at the point 410 of FIG. 4, a signal is outputted in response to a change in capacitance occurring at the point 510 corresponding to the point 410. When a touch is inputted at the point 410 or corresponding point 510, a signal waveform shown in the right-hand side of FIG. 5 may be outputted through the second signal outputting unit to the second channel c22, the third channel c23 and the fourth channel c24.

The data processing unit 120 may analyze a pulse pattern of the signal waveform shown in FIG. 5, sense a signal occurring in three channels, and calculate an X-axis coordinate of the point 510 in the third region using the sensed signal. Further, the data processing unit 120 may calculate as, for example, 2:3.5:2.5 the area ratio of pulses among the second channel c22, the third channel c23, and the fourth channel c24, which may show the pulse pattern of the second signal at different channels. The data processing unit 120 may also determine that the ratio may not correspond to the fourth region, and calculate an X-axis coordinate of the touch using the second signal.

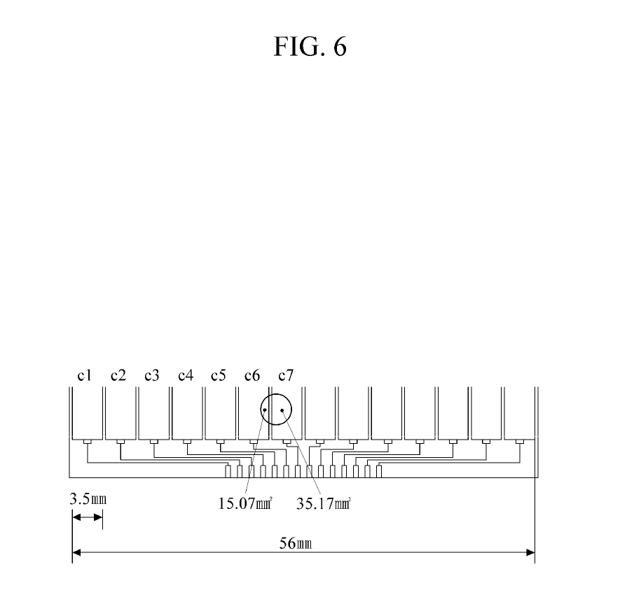

FIG. 6 is a diagram illustrating a method for calculating a location of a touch according to an exemplary embodiment of the present invention.

The data processing unit 120 may determine a location of at least one electrode pattern or channel, in which a touch may be sensed with respect to a specific direction, for example, a left direction in an X axis, calculate a touch-sensed area that may correspond to a change in capacitance sensed on the at least one electrode pattern or channel, in which the touch sensed, and calculate the location of the touch.

Referring to FIG. 6, when a touch to be recognized by touch recognition is set to have a width of 6 mm, a touch may be sensed in a portion of the sixth electrode pattern and a portion of the seventh electrode patterns of the first sensing layer 210. The data processing unit 120 may calculate the portion of the sixth electrode pattern detecting the touch as 15.07 mm², and the portion detecting the touch of the seventh electrode pattern as 35.17 mm². The data processing unit 120 may calculate the portions of the electrode patterns using a signal indicating a change in capacitance that occurs in the sixth electrode pattern and the seventh electrode pattern.

Further, if an X-axis coordinate starts from a left-to-right direction, the data processing unit 120 may calculate an X-axis coordinate based on the following equation.

X-axis coordinate=3.5 mm(width of electrode pattern)×6(location of electrode pattern, which is first sensed from a left-to-right direction)+(−15.07 mm²+35.17 mm²)/50.24 mm²×3.5 mm(width of electrode pattern)=21.8 mm.

Using the above equation, the data processing unit 120 may calculate an X-axis coordinate of the touch to be 21.8 mm.

More specifically, when a touch to be recognized by touch recognition is set to have a width of 8 mm, the data processing unit 120 may calculate a touch-sensed area in one or more of the first electrode patterns using a signal pulse pattern appearing over three of the first electrode patterns, and calculate an X-axis coordinate.

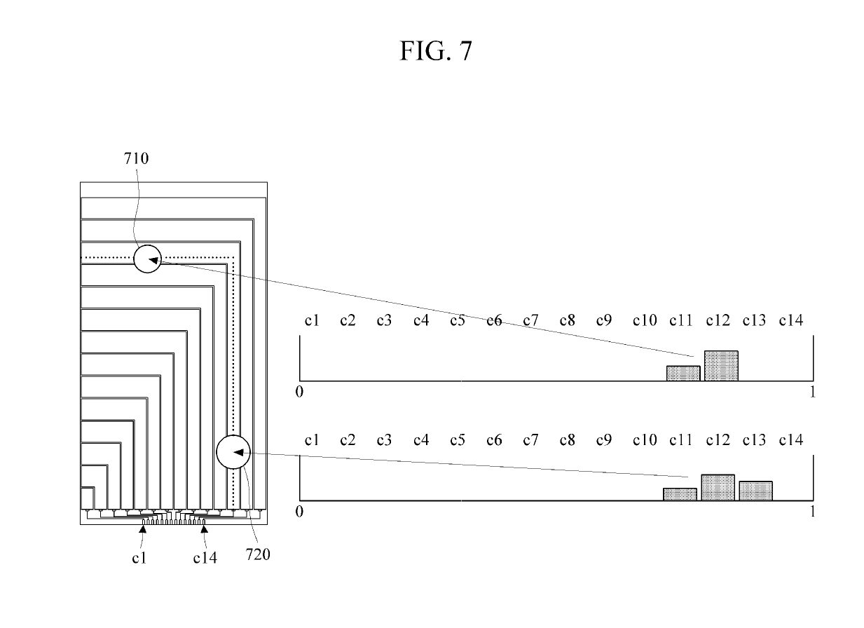

FIG. 7 is a diagram illustrating a first signal output in response to multiple touch inputs on a first sensing layer according an exemplary embodiment of the present invention.

Referring to FIG. 7, when touch inputs are detected at a point 710 and a point 720, a signal waveform shown in the right-hand side of FIG. 7 may be output through the first signal outputting unit.

As shown in the right-hand side of FIG. 7, when a touch is inputted at the point 710, a signal pulse pattern may appear over the eleventh channel c11 and the twelfth channel c12 through the first signal outputting unit. When a touch is inputted at the point 720 of FIG. 7, a signal pulse pattern may appear over the eleventh channel c11, the twelfth channel c12, and the thirteenth channel c13.

The data processing unit 120 may analyze a pattern of a signal waveform shown in FIG. 7, sense the pulse pattern occurring in the two channels with respect to the point 710, and calculate a Y-axis coordinate of the point 710 using the sensed pulse pattern. In addition, the data processing unit 120 may sense the pulse pattern occurring in the three channels with respect to the point 720, and then calculate an X-axis coordinate of the point 720 based on the sensed pulse pattern.

Furthermore, the data processing unit 120 may determine a signal generated at the point 710 as a Y-axis coordinate signal using the area ratio of pulses between channels related to the point 710, which may indicate a change in capacitance sensed in the electrode patterns in response to the touch at the point 710, and calculate a Y-axis coordinate. Similarly, the data processing unit 120 may determine a signal generated at the point 720 as an X-axis coordinate signal using the area ratio of pulses between the channels related to the point 720, which may indicate a change in capacitance sensed in the electrode patterns, and then calculate an X-axis coordinate.

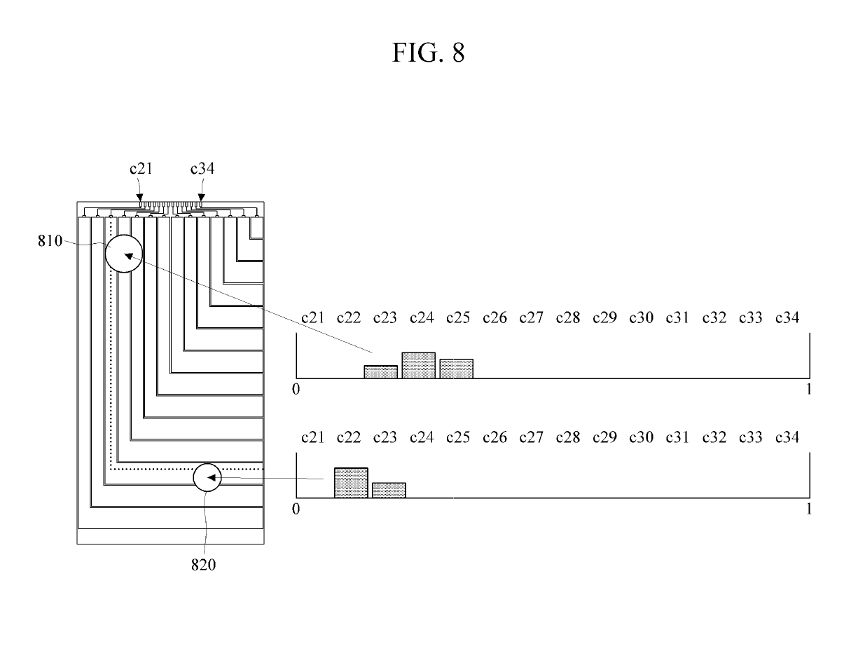

FIG. 8 is a diagram illustrating a second signal output in response to multiple touch inputs on a second sensing layer according to an exemplary embodiment of the present invention.

Referring to FIG. 8, a point 810 may correspond to the point 710 of FIG. 7. More specifically, if the first sensing layer of FIG. 7 overlaps the second sensing layer of FIG. 8, a touch input detected at a first position on the first sensing layer may also be detected on a corresponding position, which may be the same position as the first position, on the second sensing layer. Further the point 810 may indicate a location on the second sensing layer 220 at which a change in capacitance may be sensed. In addition, a point 820 may correspond to the point 720 of FIG. 7, and may indicate a location at which a change in capacitance may be sensed on the second sensing layer 220.

When a touch is inputted at the point 810 of FIG. 8, a signal pulse pattern may appear in the third channel c23, the fourth channel c24, and the fifth channel c25 through the second signal outputting unit. When a touch is inputted at the point 820 of FIG. 8, the signal pulse pattern may appear in the second channel c22 and the third channel c23 from a left-to right direction.

The data processing unit 120 may analyze the pattern of the signal waveform of FIG. 8, sense a signal pulse pattern appearing over three channels with respect to the point 810, and calculate an X-axis coordinate of the point 810 using the sensed signal pulse pattern. In addition, the data processing unit 120 may sense a signal pulse pattern appearing over two channels with respect to the point 820 and calculate a Y-axis coordinate of the point 820 using the sensed signal pulse pattern.

In addition, the data processing unit 120 may determine a signal generated at the point 810 as an X-axis coordinate signal using the area ratio of pulses between channels related to the point 810, which may indicate a change in capacitance sensed in the electrode patterns in response to the sensed touch at the point 810. The data processing unit 120 may calculate an X-axis coordinate. The data processing unit 120 may determine a signal generated at the point 820 as a Y-axis coordinate signal using the area ratio of pulses between channels related to the point 820, which may indicate a change in capacitance in the electrode patterns in response to the touch at the point 820, and calculate a Y-axis coordinate.

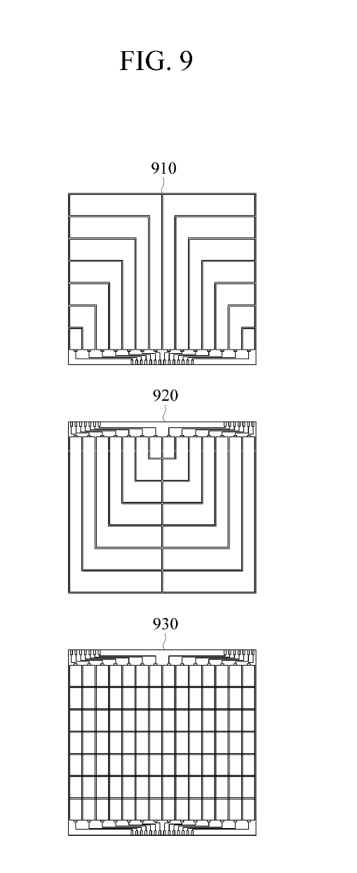

FIG. 9 is a diagram illustrating electrode patterns of a touch panel according to an exemplary embodiment of the present invention. The electrode patterns of FIG. 9 will be described with respect to sensing layers of FIG. 2, but are not limited thereto.

Referring to FIG. 9, a touch panel includes a first sensing layer 910, a second sensing layer 920, and an overlapping configuration 930 of the first sensing layer 910 and the second sensing layer 920.

Referring to FIG. 9, the first sensing layer 910 may be formed by placing a number of sensing layers or sub-sensing layers, similar to but smaller than the first sensing layer 210 of FIG. 2, in parallel or in other configurations. More specifically, FIG. 9 illustrates the first sensing layer 910 being formed by placing smaller sensing layers or sub-sensing layers, such as half-sized first sensing layers similar to first sensing layer 210 of FIG. 2, to mirror each other or to be symmetrical. However, the formation of the first sensing layer 910 is not limited thereto. As shown in FIG. 9, the first sensing layer 910 may be formed to include a first sub-sensing layer and a second sub-sensing layer having electrode patterns symmetrical to the first sub-sensing layer. Further, the first sensing layer 910 may be formed by connecting the first sub-sensing layer and the second sub-sensing layer in parallel to minor each other, which may have the same electrode patterns.

The second sensing layer 920 of FIG. 9 may be formed by placing a number of smaller sensing layers or sub-sensing layers, similar to the first sensing layers 210 of FIG. 2 in parallel or in other configurations. As shown in FIG. 9, the second sensing layer 920 may be formed to include a first sub-sensing layer and a second sub-sensing layer, which may be configured or disposed to have electrode patterns symmetrical to each other. Further, the second sensing layer 920 may be formed by connecting the first sub-sensing layer and the second sub-sensing layer in parallel to minor each other, which may have the same electrode patterns. Although illustrated as mirrored with respect to a line parallel to a side of the first and second sensing layers 910 and 920, aspects need not be limited thereto such that the first and second sub-sensing layers may be mirrored with respect to a line not parallel with respect to a side of the first and second sensing layers 910 and 920, i.e., the line may be diagonal or at an angle different that 90° with respect to a side of the first and second sensing layers 910 and 920.

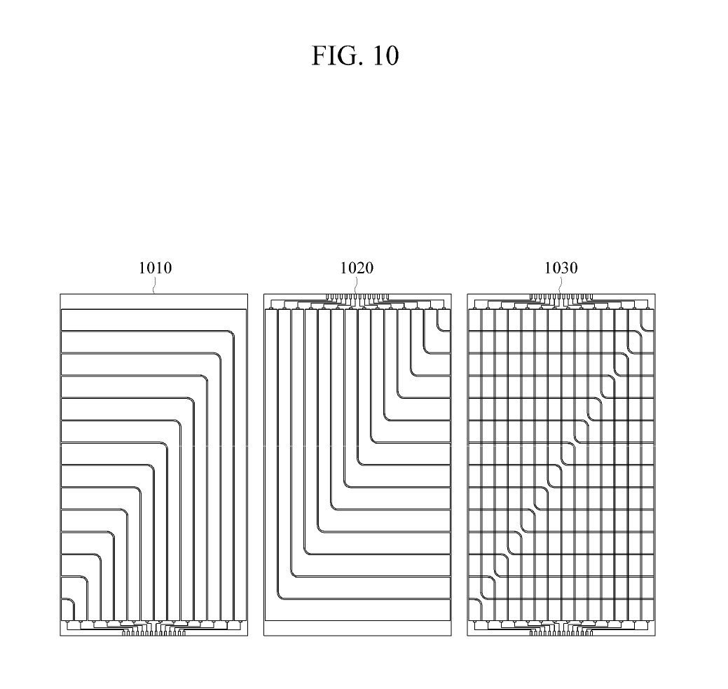

FIG. 10 is a diagram illustrating electrode patterns of a touch panel according to an exemplary embodiment of the present invention.

Referring FIG. 10, a touch panel may include a first sensing layer 1010, a second sensing layer 1020, and an overlapping configuration 1030 of the first sensing layer 1010 and the second sensing layer 1020.

In FIG. 2, the first electrode patterns of the first sensing layer 210 are bent diagonally to form an edged corner on the first sensing layer 210, and the second electrode patterns of the second sensing layer 220 are bent diagonally to from an edged corner on the second sensing layer 220. However, in FIG. 10, the first electrode patterns of the first sensing layer 1010 and the second electrode patterns of the second sensing layer 1020 are bent diagonally to form a rounded corner.

The touch sense patterns 1030 may be configured, such that the first sensing layer 1010 and the second sensing layer 1020 overlap each other. As shown in FIG. 10, the first electrode patterns of the first sensing layer 1010 and the second electrode patterns of the second sensing layer 220 are respectively bent at the diagonal dividing line to form a rounded corner. Further, when a touch is inputted on a specific rounded corner, electrode patterns adjacent to the specific rounded corner may have touch-sensed areas more equal to each other. Therefore, it may be possible to more precisely calculate an X-axis coordinate and a Y-axis coordinate when using the first sensing layer 1010 and the second sensing layer 1020 of FIG. 10.

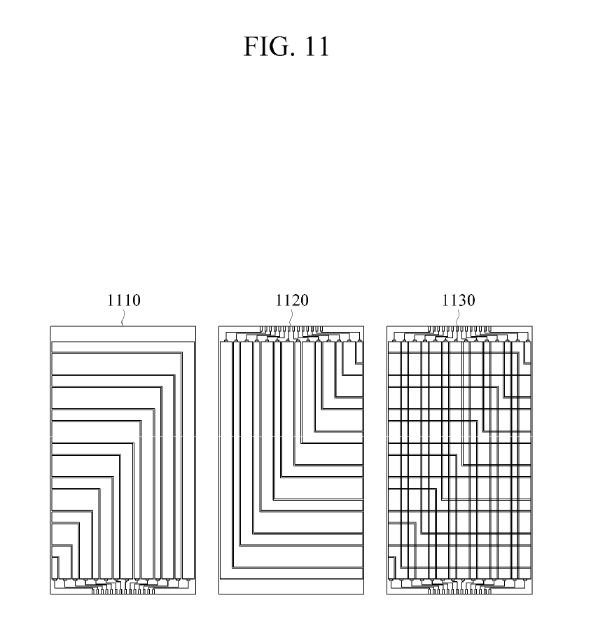

FIG. 11 is a diagram illustrating electrode patterns of a touch panel according to an exemplary embodiment of the present invention.

Referring to FIG. 11, a touch panel may include a first sensing layer 1110, a second sensing layer 1120, and an overlap configuration 1130 of the first sensing layer 1110 and the second sensing layer 1120. As shown in FIG. 11, first electrode patterns of the first sensing layer 1110 may be configured to have two or more different width values, either in a horizontal direction or in a perpendicular direction. In addition, second electrode patterns of the second sensing layer 1120 may be configured to have two or more different width values, either in a horizontal direction or in a perpendicular direction.

FIG. 12 is a cross-sectional view of a touch panel according to an exemplary embodiment of the present invention.

As shown in FIG. 12, touch panel 1200 may have a structural configuration corresponding to either a first cross section 1210 or a second cross section 1220.

The first cross section 1210 includes a first film, a second film, a first Indium Tin Oxide (ITO) layer, a first silver layer, a first Optically Clear Adhesive (OCA) layer, a third film, a second ITO layer, a second silver layer, and a second OCA layer. The first film, the second film, and the third film may be made of Polyethylene Terephthalate (PET). The first ITO layer may correspond to the first sensing layer 210 of FIG. 2, and the second ITO layer may correspond to the second sensing layer 220 of FIG. 2. However, aspects of the invention are not limited thereto, such that the first ITO layer may correspond to the second sensing layer 220 of FIG. 2, and the second ITO layer may correspond to the first sensing layer 210 FIG. 2. The first silver layer may include a wiring, which may output a signal corresponding to a change in capacitance sensed on one or more electrode patterns of the first ITO layer. In addition, the second silver layer may include a wiring, which may output a signal corresponding to a change in capacitance sensed on one or more electrode patterns of the second ITO layer.

The first ITO layer corresponding to the first sensing layer 210 of FIG. 2 may be formed with a film, such as the second PET. The second ITO layer corresponding to the second sensing layer 220 and the second silver layer may be formed with a different film, such as the third PET. More specifically, the first sensing layer 210 and the second sensing layer 220 may be formed with different films.

As shown in FIG. 12, the first cross section 1210 has a thickness of 425 micro meters (um). The first film has a thickness of 50 um, a combination of the second film and the first ITO layer has a thickness of 45 um, the first silver layer has a thickness of 10 um, the first OCA layer has a thickness of 50 um, a combination of the third film and the second ITO layer has a thickness of 160 um, the second silver layer has a thickness of 10 um, and the second OCA layer has a thickness of 100 um. Although FIG. 12 indicates specific thicknesses, aspects need not be limited thereto such that individual layers or combinations of layers may be of different thicknesses than indicated in FIG. 12.

The second cross section 1220 includes a film, a first ITO layer, a first silver to layer, an OCA layer, a second ITO layer, a second silver layer and a window (or cover). The first ITO layer may correspond to the first sensing layer 210 of FIG. 2, and the second ITO layer may correspond to the second sensing layer 220 of FIG. 2. As shown in the second cross section 1220, the first ITO layer may be adhered to the bottom surface of the OCA layer, and the second ITO layer corresponding to the second sensing layer 220 may be adhered to the top surface of the OCA layer. More specifically, the first sensing layer 210 and the second sensing layer 220 may be respectively adhered to the bottom surface and the top surface of one film.

As shown in FIG. 12, the second cross section 1220 has a thickness of 900 um. A combination of the film, the first ITO layer, and the first silver layer has a thickness of 100 um, the OCA layer has a thickness of 100 um, and a combination of the second ITO layer, the second silver layer, and the window or cover has a thickness of 700 um. Although FIG. 12 indicates specific thicknesses, aspects need not be limited thereto such that individual layers or combinations of layers may be of different thicknesses than indicated in FIG. 12.

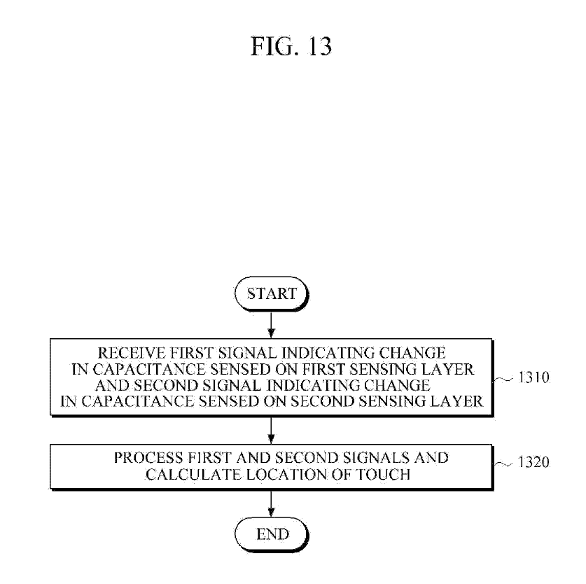

FIG. 13 is a flow chart illustrating a method for sensing a touch according to an exemplary embodiment of the present invention.

The method for sensing a touch is provided with reference to FIG. 1 to FIG. 12. More specifically, the method of FIG. 13 will be described as if performed by the apparatus of FIG. 1. However, aspects of the invention are not limited thereto. In operation 1310, when a touch is inputted on the touch panel 110, a change in capacitance may occur on the touch panel 110 and the data processing unit 120 may receive at least one of the first signal and the second signal, which may be a signal indicating a change in capacitance sensed on the first sensing layer or the second sensing layer.

In operation 1320, the data processing unit 120 may process at least one of the first signal and the second signal, and calculate a location at which a touch may be inputted. Further, the data processing unit 120 may remove noise from the first signal and the second signal, analyze a pulse pattern of the first signal and a pulse pattern of the second signal, and determine whether the first signal and the second signal correspond to an X-axis coordinate and a Y-axis coordinate, or vice versa.

In addition, based on the determination result, the data processing unit 120 may calculate the touch-sensed area in each of the first electrode patterns using the pulse pattern of the first signal, and calculate at least one of an X-axis coordinate and a Y-axis coordinate according to the touch-sensed area in one or more of the first electrode patterns. In addition, the data processing unit 120 may calculate the touch-sensed area in one or more of the second electrode patterns using the pulse patterns of the second signal, and calculate the other coordinate, which may yet to be calculated with respect to the touch input between the X-axis coordinate and the Y-axis coordinate, based on the calculated touch-sensed area of each of the first electrode patterns. The number of the pulses of the first signal may be different from the number of the pulses of the second signal.

The above-described principle and method for sensing a touch may be applied not only to when a single touch is inputted, but also when multiple touches are inputted using two or more fingers.

The methods and/or operations described above may be recorded, stored, or fixed in one or more non-transitory computer-readable storage media that may include program instructions to be implemented by a computer to control a processor to execute or perform the program instructions. The media may also include, alone or in combination with the program instructions, data files, data structures, and the like. Examples of computer-readable storage media include magnetic media, such as hard disks, floppy disks, and magnetic tape; optical media, such as Compact Disc Read-Only Memory (CD-ROM) disks and Digital Versatile Discs (DVDs); magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to sense a touch, comprising:
a touch panel to sense a touch based on a change in capacitance, the touch panel comprising:
a first sensing layer comprising a plurality of first electrode patterns, and
a second sensing layer comprising a plurality of second electrode patterns; and
a data processing unit to calculate a location coordinate of the sensed touch based on the change in capacitance.

2. The apparatus of claim 1, wherein the first sensing layer overlaps the second sensing layer to provide a grid of electrode patterns.

3. The apparatus of claim 1, wherein the first sensing layer comprises a first signal outputting unit disposed thereon to communicate with the data processing unit.

4. The apparatus of claim 1, wherein the second sensing layer comprises a second signal outputting unit disposed thereon to communicate with the data processing unit.

5. The apparatus of claim 1, wherein the first sensing layer comprises at least one of the first electrode patterns is connected to a wiring disposed on at least one of the first sensing layer and the second sensing layer to transmit a capacitance value of at least one of the first electrode pattern and the second electrode pattern to the data processing unit.

6. The apparatus of claim 1, wherein at least one of the first electrode patterns is bent to dispose a first portion of the first electrode pattern along a first axis and to dispose a second portion of the first electrode pattern along a second axis, and
at least one of the second electrode patterns is bent to dispose a first portion of the second electrode pattern along the second axis and to dispose a second portion of the second electrode pattern along the first axis.

7. The apparatus of claim 6, wherein at least one of the first electrode pattern and the second electrode pattern is bent to provide a right angle at a bending portion.

8. The apparatus of claim 6, wherein at least one of the first electrode pattern and the second electrode pattern is bent to provide a rounded corner at a bending portion.

9. The apparatus of claim 1, wherein at least one of the first sensing layer and the second sensing layer comprises a plurality of electrode patterns that are bent and spaced apart from each other with same widths disposed therebetween.

10. The apparatus of claim 1, wherein at least one of the first sensing layer and the second sensing layer comprises a plurality of electrode patterns that are bent and spaced apart from each other with at least two different widths disposed therebetween.

11. The apparatus of claim 1, wherein at least one of the first sensing layer and the second sensing layer comprises a symmetrical configuration of electrode patterns disposed thereon.

12. The apparatus of claim 1, wherein the data processing unit calculates a contact area ratio of adjacent electrode patterns corresponding to the touch input, normalizes the contact area ratio of the adjacent electrodes, and calculates coordinates of the contact area.

13. The apparatus of claim 1, wherein capacitance level corresponds to a size of a contact area of an electrode pattern.

14. The apparatus of claim 1, wherein the data processing unit calculates an X-axis coordinate and a Y-axis coordinate based on a size of a touch area detected on at least one of the first electrode patterns or the second electrode patterns.

15. The apparatus of claim 1, wherein the data processing unit calculates a touch sensed area in at least one of the first electrode patterns or the second electrode patterns using a pulse pattern.

16. The apparatus of claim 1, wherein the first sensing layer and the second sensing layer are combined as one sheet by forming electrode patterns and wiring on each surface of a film.

17. The apparatus of claim 1, wherein at least one of the first sensing layer and the second sensing layer is divided diagonally into a first region and a second region.

18. A method for sensing a touch, comprising:
receiving a signal indicating a change in capacitance on at least one of a first sensing layer and a second sensing layer in response to the touch inputted on a touch panel; and
calculating a location of the touch on the touch panel based on the change in capacitance.

19. The method of claim 18, wherein the first sensing layer overlaps the second sensing layer to provide a grid of electrode patterns.

20. The method of claim 18, wherein at least one of the first sensing layer and the second sensing layer comprises wiring disposed thereon.

21. The method of claim 18, wherein at least one of an X-axis coordinate and a Y-axis coordinate of the location is calculated based on a size of an area of the touch input.

22. The method of claim 18, wherein at least one of the first sensing layer and the second sensing layer comprises a plurality of electrode patterns.

23. The method of claim 22, wherein the calculating of the location of the touch comprises:
calculating a contact area ratio of adjacent electrode patterns corresponding to the touch input;
normalizing the contact area ratio of the adjacent electrodes; and
calculating coordinates of the contact area.

24. The method of claim 22, wherein at least one of the electrode patterns is bent to dispose a first portion of the electrode pattern along a first axis and to dispose a second portion of the electrode pattern along a second axis.

25. A touch panel, comprising:
a first sensing layer comprising a bent first electrode pattern; and
a second sensing layer comprising a bent second electrode pattern,
wherein the first sensing layer overlaps the second sensing layer to form a grid of electrode patterns, and
a signal outputting unit is disposed on at least one of the first sensing layer and the second sensing layer.
